(19) United States
(12) Patent Application Publication
(10) Pub. No.: US 2015/0285489 A1
(43) Pub. Date: Oct. 8, 2015

(54) PROTECTIVE, RESPONSIVE DOOR-LIGHTING SYSTEM

(71) Applicant: Clark Herold Ulysse, Minneapolis, MN (US)

(72) Inventor: Clark Herold Ulysse, Minneapolis, MN (US)

(21) Appl. No.: 14/244,871

(22) Filed: Apr. 3, 2014

(51) Int. Cl. F21V 33/00; E05F 15/74; F21S 9/02; H05B 37/02; F21V 23/04

(52) U.S. Cl. CPC F21V 33/006; H05B 37/0227; H05B 37/0281; F21V 23/0471; F21S 9/02; E05F 15/74; E05F 2015/765

(57) ABSTRACT

A door with motion or object sensitive light response has a door structure; a motion or object sensor on the door structure; a power source embedded in or on the door structure; a light system on at least one face of the door; a logic component between the power source and the light; wherein the logic source is configured to respond to signals from the motion or object sensor to close a circuit between the power source and the light to power the light.

### BACKGROUND OF THE INVENTION

1. Field of the Invention

The present invention relates to the field or doors, door lighting and automatic, sensor-activated door lighting

2. Background of the Art

Security and safety issues around buildings and especially dwellings often relate to physical aspects of the dwelling that allows for or even invites physical accidents. Inadequate or inappropriate lighting frequently contributes to safety issues, especially ay night around the house or dwelling. Especially at night, both in unfamiliar rooms or even in one's regular abode with less than full awareness or capability (e.g., due to tiredness, illness or diminished capacity), accidents are far more likely than during well-lit conditions.

Stairways in dwellings can be equipped with sensors that automatically turn on lights as individuals enter the stairwells, and “clapping” sensitive devices are used to provide area specific lighting. The intentionally triggered systems (such as clappers and voice-activated sensors) still require awareness and intent to activate lighting. These are area specific and additional lighting systems that do not address all safety issues, and additional systems are desirable.

Various sensing systems and lighting systems are known in the art.

### SUMMARY OF THE INVENTION

A door is provided with a sensor, power source and low power lights on at least one surface of the door. A processor or logic system in the door acts to receive signals from the sensor of motion, and activates the lights for a time period. Lights may be provided on one or both sides of the door. The lighting and logic/sensor system may be embedded into the door or provided as an add-on after construction of the door.

### BRIEF DESCRIPTION OF THE FIGURES

FIG. 1 shows a perspective view of a door construction according to the present technology with a sensor and lights.

FIG. 2 shows an exploded view of a door according to the present technology.

### DETAILED DESCRIPTION OF THE INVENTION

A door with motion or object sensitive light response has a door structure (or solid rectangular form); a motion or object sensor on the door structure; a power source embedded in or on the door structure; a light system on at least one face of the door; a logic component between the power source and the light; wherein the logic source is configured to respond to signals from the motion or object sensor to close a circuit between the power source and the light to power the light. The structure of the door or an retrofit system can be provided in standard door sizes for use in existing structures or in standard construction.

A door is provided with a sensor, power source (preferably a battery stored and rechargeable within the door structure) and low power lights (e.g., a series of LED lights is preferred, but bulbs, such as incandescent bulbs or any sort of light-emitting arrangement is useful) on at least one surface of the door. The bulbs should be banked within a cover to better disperse the light emitted. A processor or logic system in the door acts to receive signals from the sensor of motion, and activates the lights for a time period. Upon sensing movement or sound (which may be controlled by exterior input to the sensor or reflected emissions such as ultrasonic waves), the logic closes the circuit between the battery and the lights, causing light to be emitted on a door surface. Lights may be provided on one or both sides of the door, with sensors on one or both sides of the door. The lighting and logic/sensor system may be embedded into the door or provided as an add-on after construction of the door.

It is preferred that the batter is rechargeable, although replaceable batteries may be provided. The batteries should be one or more batteries totaling from 1.5 to 24 Volts. The battery may be fitted with a direct connection that extends to a surface or edge (side) of the door so that a power pack or electrical plug can be connected to the connection and then to a socket or power pack to charge the battery. It is also possible to have rechargeable batteries that can be inserted into the door frame, replaced, and then charged external to the door.

The sensor may be any standard commercially available motion sensor, preferably a sensor having a sensitivity control thereon. It is desirable to have the sensitivity control available at an external location from the door (e.g., adjacent hinges for the door), but a wireless (wifi, RF or other control) system may be provided for ease of adjustment of the sensor. The sensor may swivel or pivot in a socket in the door to also adjust its angle of sensitivity. The sensitivity may be adjusted or programmed for size of objects moving, speed of objects moving, duration of movement and the like. A simplest format would be to have a switch/button entry for the sensor where specific sensitivities can be entered (e.g., low, medium and high) or to have a slide adjustment where analog levels from off to high may be entered manually.

The door may be pre-constructed with all of the components built more securely into the structure of the door, or, especially with the lighting elements positioned only on an interior (room-side versus hall-side) side of a door. The system may be retrofit to a door surface by providing an attachable sheet or panel integrating the described components. Any electrical connection would then likely be into the sheet or panel and not into the door structure.

These and other aspects of the technology may be better understood by a review of the Figures.

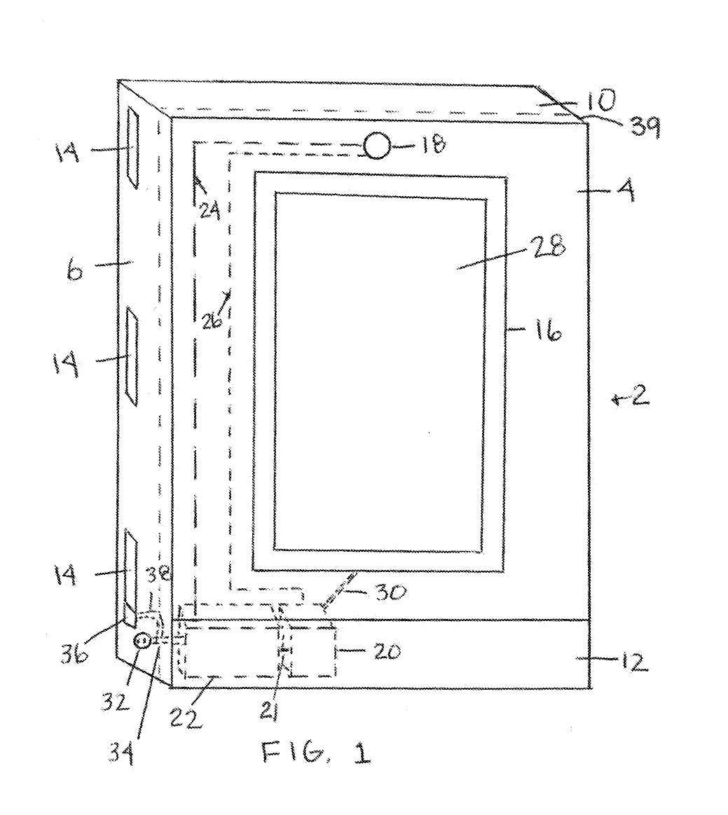

FIG. 1 shows a door 2 with a solid panel 4. A side/edge 6 of the door 4 is shown with three hinges 14 used to secure the door 4 to a frame (not shown). The top 10 of the door 4 is shown, along with a permanent or temporary (removeable) kick plate 12 is shown. In one embodiment of a preferred location of elements, but which locations may be varied, are shown a logic element 20 and a battery 22 as described herein. The logic element 20 may be preprogrammed for sensitivity and function (on-off when signals received, variation of voltage, time duration of closed circuit when signaled, and the like) or may be externally adjustable or externally programmable. A motion sensor 18 is shown near the top 10 of the door 4. The sensor '18 is powered by the battery 22 through line 24, and the sensor 18 is in communication with the logic device or switch 20 through communication line 26. For convenience, the battery 22 also provides power to and through the logic device 20. When the sensor 18 registers a triggering activity for turning on the light 16, a signal is sent by the sensor 18 through communication line 26 to the logic device 20, which may effect or cause a circuit between the battery 22 (or from the battery) through the logic device 20 to close and power the light 16. Although a sliding door May be used as the door structure, hinged doors are preferred in the practice of the present technology.

The light 16 may be a series or parallel array of LED components or bulbs, including incandescent bulbs (not shown), preferably behind a cover element. Circuitry to and along the light 16 (e.g., circuitry 30 from the logic device 20) is used to transport the power to individual bulbs in the light 16. A central area 28 is shown within the light 16 which is shown as a continuous track of lights, but may be independent light elements (not shown). If the light system of the present technology were designed to be retrofit to a door, an entire panel 39 having the essential components of the sensor 18, light 16, door surface 4, communication/power links 24, 26 and the like) would be self-contained, and only the battery 20 and sensor 22 might need to be built into the door. It is also possible to have the battery 20 and sensor 22 built into a panel including the kick-plate 12 so that an entirely functional lighting system could be retrofit to a door.

Also shown as optional components are the electrical socket 32 connected through a wire 32 and/or a side-mounted socket 36 into which a male electrical cord (not shown) could be connected through wire 38 to wire 32 and then to the battery 22. An electrical connection 21 between the logic 20 and the battery 20 is shown.

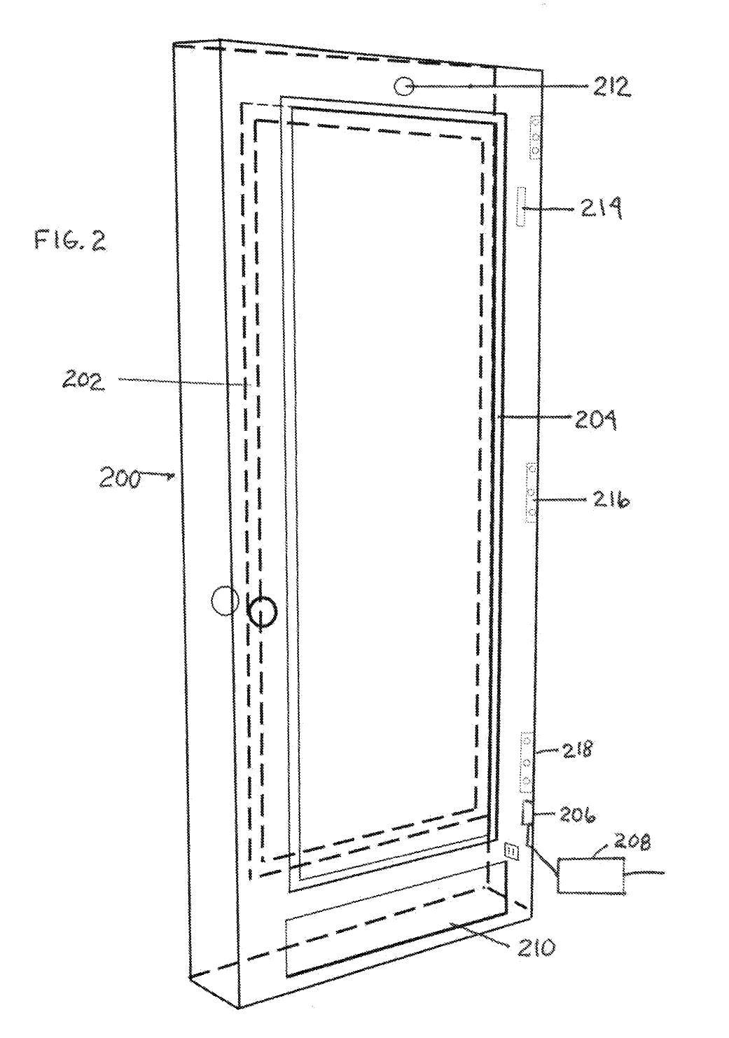

FIG. 2 shows an exploded perspective view of the door system 200. An LED strip 202 is shown as a substrate, with lenses (not shown) and wiring channels (not shown) routed ion the door to fit them. A translucent (or transparent) cover 204 would also fit over the LED strip 202.

A pivoting barrel connector 206 that fits adjacent to or over the hinge 218 (at its pivot point, for example) is shown connected to an external AC adapter for 12 volt direct current and 6 amp (preferable maximum) use. The open space 210 for insertion of the rechargeable battery is shown at the bottom of the door system 200. The exterior of the sensor 212 is shown at the top of the door. This may be a back-to-back motion detector modified with over-rides and switches. A dimmer module 214 is shown which controls the intensity of the light from the LED strip 202 by sensing ambient light and accordingly moderating or intensifying emissions from the LED light strip 202. Modulation would be also be controllable by the processor 22 in communication with the dimmer module 214. The hinge 216 may be a power transfer hinge (connected to the battery or external energy source) if a barrel connector 206 is not used.

The logic may be a processor, field programmable gated array, hardwired board, ASIC (Application-Specific Integrated Circuit) or other functional logic system that is designed or programmed or programmable to perform desired and intended functions in the sensor and lighting system. The sensor recognizes movement at a designed or preset distance, and a signal is sent to the logic system. The logic system then interprets the signal and initiates an action or does not initiate an action based upon its interpretation of the signal. The logic and its control capability can effect various functions such as:
Close the circuit until manually opened;
Close the circuit at a preset power flux intensity;
Close the circuit at a preset power flux intensity for a fixed period of time;
Close the circuit at a preset power flux intensity for a fixed period of time and diminish the power flux intensity over that time period;
Close the circuit at a preset power flux intensity for a fixed period of time and alter the response (e.g., increase sensitivity) after an initial signal;
Ignore the signal; and
Ignore the signal and recognize that a signal has been received.

Although specific components and functions have been identified, one of ordinary skill in the art recognizes that alternatives and equivalents may be used within the generic scope of the invention.

What is claimed:

1. A door with motion or object sensitive light response comprising:
a) a door structure;
b) a motion or object sensor on the door structure;
c) a power source embedded in or on the door structure;
d) a light system on at least one face of the door;
e) a logic component between the power source and the light;
f) the logic source configured to respond to signals from the motion or object sensor to close a circuit between the power source and the light to power the light.

2. The door of claim 1 wherein the logic source comprises hardware configured to maintain a closed circuit for a predetermined amount of time in keeping the light powered.

3. The door of claim 1 wherein the logic source comprises hardware configured to maintain a closed circuit for a predetermined amount of time in keeping the light powered and vary the power transmitted to the light from the power source to vary emitted light intensity.

4. The door of claim 1 wherein the power source comprises a battery within the door structure.

5. The door of claim 4 wherein the battery is a rechargeable battery and an edge of the door structure has a socket in electrical connection to the rechargeable battery.

6. The door of claim 3 wherein the power source comprises a battery within the door structure.

7. The door of claim 6 wherein the battery is a rechargeable battery and an edge of the door structure has a socket in electrical connection to the rechargeable battery.

8. The door of claim 2 wherein wiring between the sensor, logic source and power source is embedded within the door structure.

9. The door of claim 3 wherein wiring between the sensor, logic source and power source is embedded within the door structure.

10. The door of claim 4 wherein wiring between the sensor, logic source and power source is embedded within the door structure.

11. The door of claim 5 wherein wiring between the sensor, logic source and power source is embedded within the door structure.

12. The door of claim 6 wherein wiring between the sensor, logic source and power source is embedded within the door structure.

13. The door of claim 7 wherein wiring between the sensor, logic source and power source is embedded within the door structure.

14. The door of claim 1 wherein the logic device, the light system, motion or object sensor and power source are embedded in a panel on one surface of the door structure.

15. The door of claim 2 wherein the logic device, the light system, motion or object sensor and power source are embedded in a panel on one surface of the door structure.

16. The door of claim 3 wherein the logic device, the light system, motion or object sensor and power source are embedded in a panel on one surface of the door structure.
